(19) United States
(12) Patent Application Publication
(10) Pub. No.: US 2020/0278697 A1
(43) Pub. Date: Sep. 3, 2020

(54) THRUSTER CONTROLLER AND ATTITUDE CONTROLLER

(71) Applicant: DENSO CORPORATION, Kariya-city (JP)

(72) Inventors: Satoru YOSHIKAWA, Nisshin-city (JP); Takenori MATSUE, Nisshin-city (JP); Tetsuji MITSUDA, Kariya-city (JP); Masataka HIRAI, Kariya-city (JP)

(21) Appl. No.: 16/734,448

(22) Filed: Jan. 6, 2020

(30) Foreign Application Priority Data
Jan. 8, 2019 (JP) 2019-001178

(51) Int. Cl. G05D 1/08; B64C 39/02

(52) U.S. Cl. CPC G05D 1/085; G05D 1/0825; B64C 2201/14; B64C 2201/108; B64C 39/024

(57) ABSTRACT

A thruster controller is used in a flying device that has at least two thrusters and a main controller that outputs an instruction value to the thruster for controlling a thrust of the thruster. The thruster controller includes an instruction value obtainer and an instruction value generator. The instruction value obtainer obtains an instruction value that is output from the main controller to the thruster based on an assumption that a propeller pitch is fixed. The instruction value generator outputs, to a pitch changing mechanism of the thruster, a propeller pitch instruction value generated from the obtained instruction value for setting the propeller pitch, and outputs, to a motor, a corrected rotation number instruction value for setting a rotation number of the motor by correcting the instruction value based on the propeller pitch instruction value.

### CROSS REFERENCE TO RELATED APPLICATION

The present application is based on and claims the benefit of priority of Japanese Patent Application No. 2019-001178, filed on Jan. 8, 2019, the disclosure of which is incorporated herein by reference.

### TECHNICAL FIELD

The present disclosure generally relates to a thruster controller and an attitude controller of a flying device.

### BACKGROUND INFORMATION

In recent years, the spread of flying devices, i.e., a so-called drone, has progressed. Such a flying device comprises a plurality of thrusters having propellers driven by a motor. The flying device changes its flight attitude and flight state by controlling a thrust generated by the thruster. Flying devices are becoming more modularized, which means that various airframes manufactured by many suppliers are controlled by using a general-purpose controller.

However, in order to make the general-purpose controller applicable to growing number of different airframes, the control system, i.e., control specification in other words, is unified. Therefore, even if the specifications of the airframe of the flying device are changed, the general-purpose controller cannot utilize, i.e., have access to, all the specifications of various airframes. As a result, there may be a problem that, under control of the general-purpose controller, for example, the flying device cannot fully perform to its capacity, which improves day by day.

### SUMMARY

It is an object of the present disclosure to provide a thruster controller that is capable of making a flying device fully exhibit its capacity even when a general-purpose controller is used. Another object of the present disclosure is to provide an attitude controller that is capable of making a flying device fully exhibit its capacity by adding functions to the general-purpose controller.

### BRIEF DESCRIPTION OF THE DRAWINGS

Objects, features, and advantages of the present disclosure will become more apparent from the following detailed description made with reference to the accompanying drawings, in which;

FIG. 1 is a block diagram of a configuration of a flying device according to a first embodiment of the present disclosure;

FIG. 2 is a schematic diagram of the flying device according to the first embodiment of the present disclosure;

FIG. 3 is a perspective view of a pitch changer mechanism used in a thruster of the flying device according to the first embodiment of the present disclosure;

FIG. 4 is a graph of relationship between a motor rotation number, a propeller pitch and a propulsion force generated by the thruster;

FIG. 5 is a graph of motor efficiency per unit output based on a relationship between the motor rotation number, the thruster propulsion force, and the propeller pitch;

FIG. 6 is a diagram of a process in an automatic control mode of the flying device according to the first embodiment of the present disclosure;

FIG. 7 is a diagram of a process in a manual control mode of the flying device according to the first embodiment of the present disclosure;

FIG. 8 is a diagram of a process in the auto-control mode of the flying device according to a second embodiment of the present disclosure;

FIG. 9 is a block diagram of a configuration of the flying device according to a third embodiment of the present disclosure;

FIG. 10 is a diagram of a process in the auto-control mode of the flying device according to the third embodiment of the present disclosure;

FIG. 11 is a schematic diagram of a configuration of the flying device according to a fourth embodiment of the present disclosure; and

FIG. 12 is a block diagram of a configuration of an attitude controller according to a fifth embodiment of the present disclosure.

### DETAILED DESCRIPTION

Hereinafter, a plurality of embodiments of a flying device using a thruster controller are described based on the drawings. Components that are substantially the same in the plurality of embodiments are denoted by the same reference numerals without repeating the description of the same components.

### First Embodiment

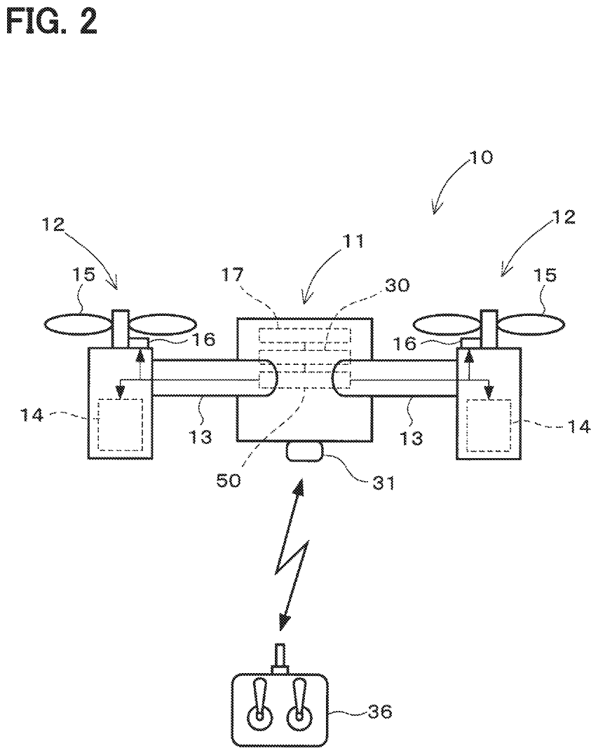

As shown in FIG. 2, the flying device 10 according to the first embodiment includes a main body 11 and a plurality of thrusters 12. In the first embodiment, the flying device 10 includes four thrusters 12. In such a case, the main body 11 has four arms 13 extending radially outward in the radial directions, and the thrusters 12 are provided at the tips of each of the arms 13, respectively. The main body 11 is not limited to the radially extending arms 13 but may also be formed in an annular shape, and a plurality of thrusters 12 may be provided along the circumferential direction.

The thrusters 12 each have a motor 14, a propeller 15 and a pitch changing mechanism 16. The motor 14 is a drive source for driving the propeller 15. The motor 14 is driven by electric power supplied from a power source such as a battery 17 housed in the main body 11. The rotation of the motor 14 is transmitted to the propeller 15. The propeller 15 is rotationally driven by the motor 14. The pitch changing mechanism 16 changes a pitch of the propeller 15.

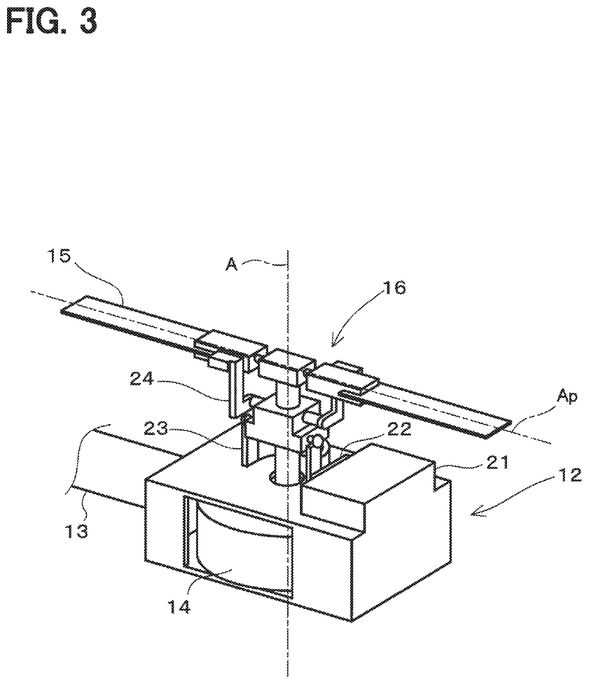

An example of the pitch changing mechanism 16 is described with reference to FIG. 3. The pitch changing mechanism 16 shown in FIG. 3 is an example of many variations, and the mechanism 16 is not limited to this example as long as the pitch changing mechanism 16 can change the pitch of the propeller 15 and can be applied to the thruster 12 of the flying device 10. The pitch changing mechanism 16 includes a servomotor 21, a lever member 32, a link member 23, and a changing member 24. The rotation of the servomotor 21 is transmitted to the propeller 15 through the lever member 22, the link member 23, and the changing member 24. The rotation of the servomotor 21 is converted to the rotation of the propeller 15 about a propeller axis Ap perpendicular to a rotation center A of the propeller 15 during the transmission via the lever member 22, the link member 23 and the change member 24. That is, when the servomotor 21 rotates, the propeller 15 rotates about the propeller axis Ap. A rotation angle of the propeller 15 rotating around the propeller axis Ap is referred to as a “pitch” or a “propeller pitch.” Thereby, the pitch of the propeller 15 changes between a pitch generating a thrust for ascent and a pitch generating a thrust for descent. The amount of change in the pitch of the propeller 15 corresponds to a rotation angle of the servomotor 21. The thrust generated by the thruster 12 varies with the number of rotations of the motor 14 that rotationally drives the propeller 15 and the pitch of the propeller 15.

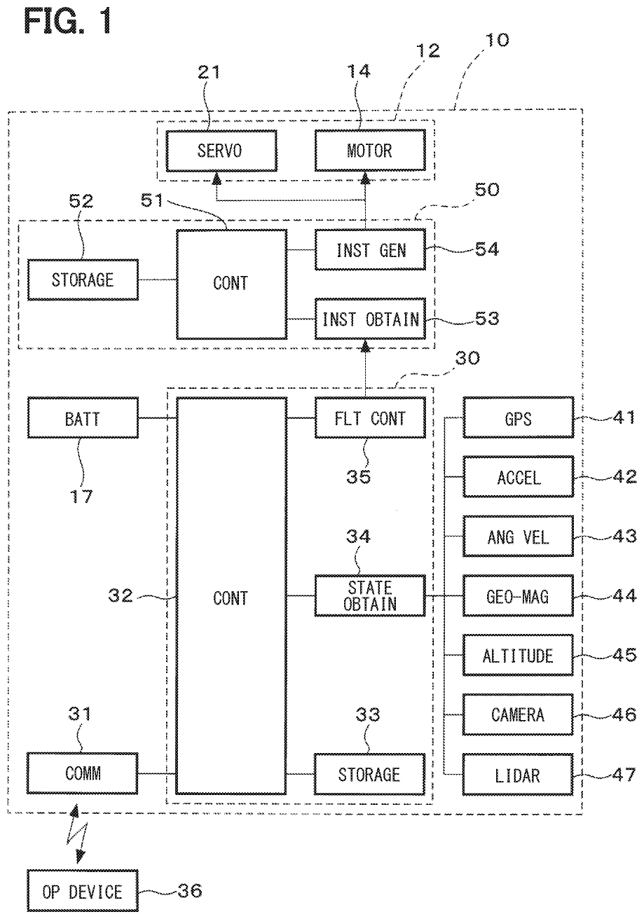

The flying device 10 includes a main controller 30 and a communication unit 31 as shown in FIGS. 1 and 2. The main controller 30 is housed in the main body 11 as shown in FIG. 2 and connected to the battery 17. The main controller 30 is a modularized general-purpose controller. The main controller 30 has a control operation unit 32 and a storage unit 33 as shown in FIG. 1. The control operation unit 32 is implemented by a microcomputer having a CPU, a ROM, and a RAM. The control operation unit 32 controls the entire flying device 10 by executing a computer program stored in the ROM by using the CPU. The control operation unit 32 realizes a state obtainer 34 and a flight controller 35 as software by executing a computer program. The state obtainer 34 and the flight controller 35 are not limited to software, but may also be realized by hardware using a dedicated electronic circuit, or by cooperation of software and hardware. The storage unit 33 has, for example, a non-volatile memory. The storage unit 33 stores a flight plan as a set data prepared in advance. The flight plan includes, for example, a flight route on which the flying device 10 flies, a flight altitude, and the like. The storage unit 33 may be shared with the RAM and the RAM of the control operation unit 32. The communication unit 31 communicates wirelessly or by wire with an operating device 36 operated by an operator.

The state obtainer 34 obtains a flight state of the flying device 10 from an inclination of the main body 11, an acceleration applied to the main body 11 and the like. More specifically, the state obtainer 34 is connected to a GPS sensor 41, an acceleration sensor 42, an angular velocity sensor 43, a geomagnetic sensor 44, an altitude sensor 45, and the like. The GPS sensor 41 receives a GPS signal output from a GPS (Global Positioning System) satellite. Further, the acceleration sensor 42 detects an acceleration applied to the main body 11 in three axial directions of an X axis, a Y axis and a Z axis in three dimensions. The angular velocity sensor 43 detects an angular velocity applied to the main body 11 in the three axial directions in three dimensions. The geomagnetic sensor 47 detects a geomagnetism in the three axial directions in three dimensions, The altitude sensor 45 detects an altitude in the vertical direction,

The state obtainer 34 detects a flight attitude, a flight direction and a flight speed of the main body 11 from the GPS signal received by the GPS sensor 41, the acceleration detected by the acceleration sensor 42, the angular velocity detected by the angular velocity sensor 43, the geomagnetism detected by the geomagnetic sensor 44 and the like. In addition, the state obtainer 34 autonomously detects a flight position of the main body 11 from the GPS signal detected by the GPS sensor 41 and detection values of various sensors. Furthermore, the state obtainer 34 detects the flight altitude of the main body 11 from the GPS signal received by the GPS sensor 41 and the altitude detected by the altitude sensor 45. In such manner, the state obtainer 34 obtains information necessary for the flight of the flying device 10, such as the flight attitude, the flight position, and the flight altitude of the main body 11, as a flight state. The state obtainer 34 may also be connected to a camera 46 that obtains a visible image, or a LIDAR (Light Detection And Ranging) 47 that measures a distance to a surrounding object, in addition to these various sensors.

The flight controller 35 controls the flight of the flying device 10 by an automatic control mode or a manual control mode. The automatic control mode is a mode in which the flying device 10 is caused to fly automatically without an operation of the operator. The operator of the flying device 10 can arbitrarily switch between the automatic control mode and the manual control mode, In the automatic control mode, the flight controller 35 automatically controls the flight of the flying device 10 in accordance with the flight plan stored in the storage unit 33. That is, in the automatic control mode, the flight controller 35 controls the thrust generated by the thruster 12 based on the flight state of the main body 11 obtained by the state obtainer 34. Thereby, the flight controller 35 causes the flying device 10 to automatically fly according to the flight plan stored in the storage unit 33 regardless of the operation of the operator.

The manual control mode is a flight mode in which the flying device 10 is caused to fly according to the operation of the operator. In the manual control mode, the operator controls the flight state of the flying device 10 through the operating device 36 provided separately and remotely from the flying device 10. The flight controller 35 controls the thrust generated by the thruster 12 based on the operation input by the operator through the operating device 36 and the flight state obtained by the state obtainer 34. Thereby, the flight controller 35 controls the flight of the flying device 10 in accordance with an intention of the operator.

The flight controller 35 outputs an instruction value to control the thrust generated by the thruster 12 in the automatic control mode or in the manual control mode. In the first embodiment, the flight controller 35 outputs a rotation number instruction value Rx as an instruction value. The rotation number instruction value Rx is a value for instructing the rotation number of the motor 14 to control the thrust generated by the thruster 12 based on an assumption that the pitch of the propeller 15 in the thruster 12 is fixed. That is, when controlling the thrust generated by the thruster 12, the existing general-purpose main controller 30 controls the number of rotations of the motor 14 based on an assumption that the pitch of the propeller 15 is fixed. Therefore, the flight controller 35 of the main controller 30 sets the thrust requested to the thruster 12, and also sets the number of rotations of the motor 14 according to the set thrust. The flight controller 35 outputs, for controlling the set rotation number by the motor 14 of the thruster 12, the rotation number instruction value Rx corresponding to the set rotation number. The thruster 12 changes the rotation number of the motor 14 based on the rotation number instruction value Rx, and generates a thrust corresponding to the set rotation number of the motor 14. Thus, the flight controller 35 outputs the rotation number instruction value Rx in order to control the rotation number of the motor 14 in the thruster 12.

Next, a thruster controller 50 according to the first embodiment is described. The thruster controller 50 is provided between the main controller 30 and the thruster 12 in the flying device 10. That is, the thruster controller 50 is an additional unit that is added between the main controller 30 and the thruster 12. In the case of the first embodiment, the thruster controller 50 controls four thrusters 12. That is, the thruster controller 50 of the first embodiment is connected to one main controller 30, and controls four thrusters 12 provided in the flying device 10.

The thruster controller 50 includes a control operation unit 51, a storage unit 52, an instruction value obtainer 53, and an instruction value generator 54. The control operation unit 51 is configured by a microcomputer having a CPU, a ROM, and a RAM. The control operation unit 51 realizes the instruction value obtainer 53 and the instruction value generator 54 as software by executing a computer program stored in the ROM by the CPU. The instruction value obtainer 53 and the instruction value generator 54 are not limited to software, and may be realized by hardware or cooperation of software and hardware using a dedicated electronic circuit. Further, the entire thruster controller 50 may be configured as hardware as a dedicated electronic circuit.

The storage unit 52 includes, for example, a non-volatile memory. The storage unit 52 may be shared with the ROM and the RAM of the control operation unit 51. The instruction value obtainer 53 obtains the rotation number instruction value Rx output from the flight controller 35 of the main controller 30. That is, the rotation number instruction value Rx output from the flight controller 35 is input to the instruction value obtainer 53 of the thruster controller 50.

The instruction value generator 54 generates a propeller pitch instruction value Px and a corrected rotation number instruction value Rr from the rotation number instruction value Rx obtained by the instruction value obtainer 53. The propeller pitch instruction value Px is an instruction value for setting the pitch of the propeller 15 to be changed by the pitch changing mechanism unit 16. The corrected rotation number instruction value Rr is an instruction value for setting the rotation number of the motor 14 in consideration of the propeller pitch instruction value Px, As described above, the rotation number instruction value Rx output from the main controller 30 is the rotation number of the motor 14 corresponding to the thrust required of the thruster 12 based on an assumption that the pitch of the propeller 15 is fixed. It has been decided, The instruction value generator 54 distributes the thrust generated by the thruster 12 into the thrust generated by the change of the pitch of the propeller 15 and the thrust generated by the rotation of the propeller 15 with the rotation of the motor 14. Thereby, the instruction value generator 54 changes the propeller pitch instruction value Px for changing the pitch of the propeller 15 and the rotation number of the motor 14 from the rotation number instruction value Rx set by the main controller 30. The corrected rotation number instruction value Rr of is generated. As a result, the thrust generated by the thruster 12 is maintained corresponding to the rotation number instruction value Rx output from the main controller 30, while the thrust by the change of the pitch of the propeller 15 and the rotation number of the propeller 15 are Divided into thrust by change.

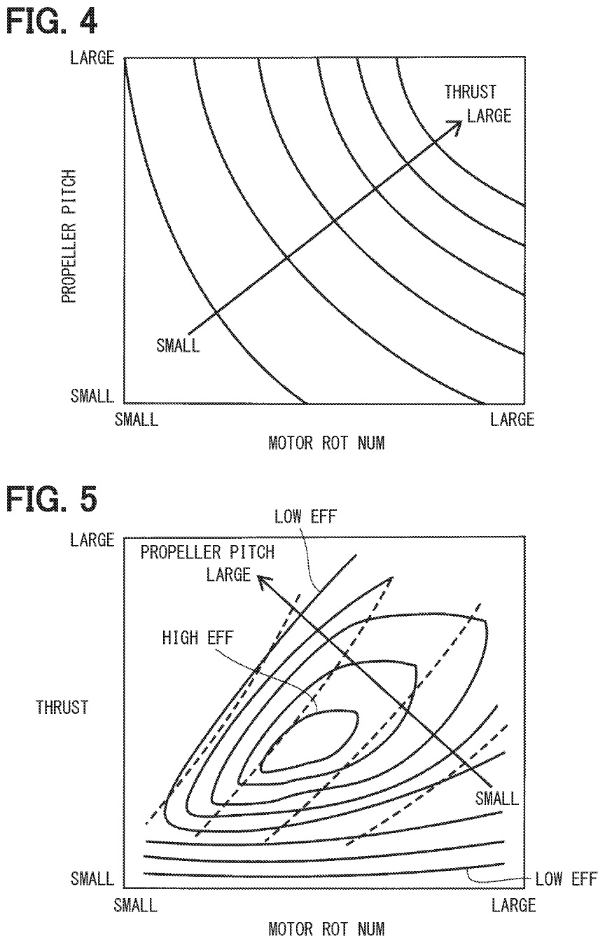

In such a case, the instruction value generator 54 distributes the thrust to the change of the pitch and the change of the rotation number, for example, giving priority to the response, giving priority to the efficiency, or achieving balance between the response and the efficiency.. The rotation number of the motor 14, the pitch of the propeller 15, and the thrust generated by the thruster 12 have a relationship as shown in FIG. 5. Further, there is a relationship as shown in FIG. 5 between the number of rotations of the motor 14, the thrust generated by the thruster 12, the pitch of the propeller 15, and the efficiency. The instruction value generator 54 distributes the thrust to the change of the pitch and the change of the rotation number at an arbitrary ratio, using the correlation as shown in FIGS. 4 and 5. In such a case, the ratio of the distribution of the thrust is arbitrary according to the performance required of the flying device 10, the specification of the flying device 10, etc. set to the ratio of distribution of the set driving force is stored in the storage unit 52 as, for example, a mathematical expression or a map. Efficiency is electrical efficiency and means the efficiency per unit output of the motor 14. Therefore, as the efficiency improves, the power consumption for the same amount of thrust decreases.

The instruction value generator 54 outputs the created propeller pitch instruction value Px to the servomotor 21 of the pitch changing mechanism unit 16. The servomotor 21 is driven based on the propeller pitch instruction value Px. As a result, the propeller 15 rotates about the propeller axis Ap by the rotation of the servomotor 21, and the pitch is changed. Further, the instruction value generator 54 outputs the generated corrected rotation number instruction value Rr to the motor 14 of the thruster 12. The motor 14 is driven based on the corrected rotation number instruction value Rr. Thus, the propeller 15 rotates at a rotation number based on the corrected rotation number instruction value Rr. As a result, the pitch of the propeller 15 of the thruster 12 is changed using the rotation number instruction value Rx output from the main controller 30, and the rotation number is also changed.

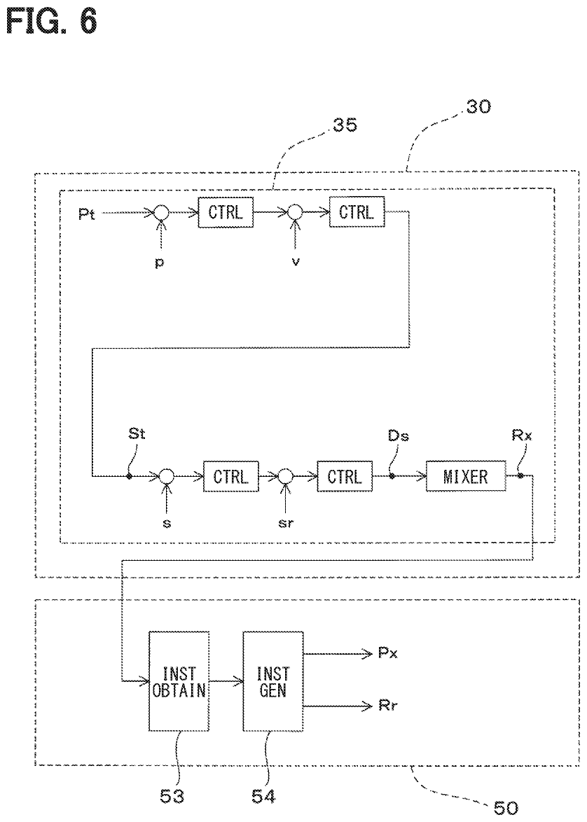

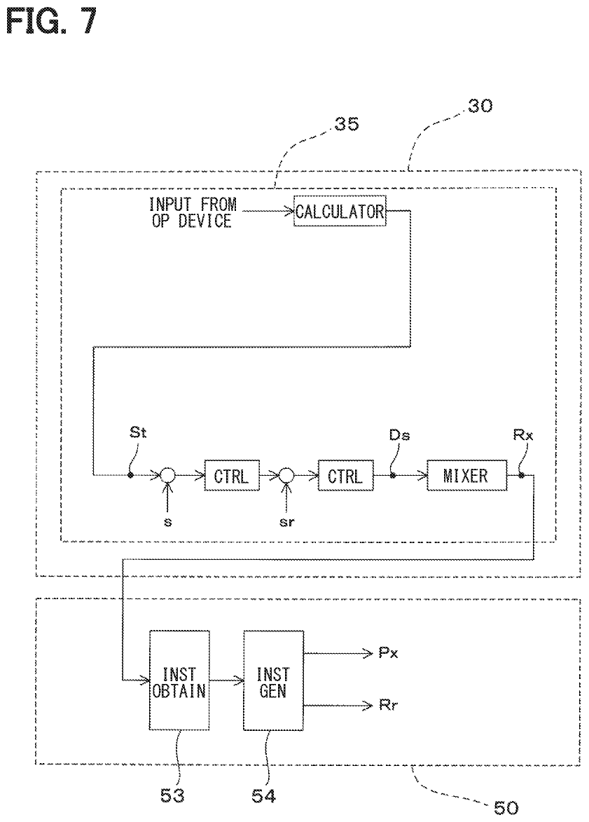

Next, the flow of generation of a propeller pitch instruction value Px and a corrected rotation number instruction value Rr by the thruster controller 50 having the above-described configuration is described. In the automatic control mode, a process is performed as shown in FIG. 6. The flight controller 35 of the main controller 30 obtains a target position Pt based on the flight plan stored in the storage unit 33. The state obtainer 34 obtains an estimated value of the position at which the flying device 10 is flying from the GPS sensor 41 or the like as an estimated position value p. The flight controller 35 obtains an estimated speed value v in addition to the obtained target position Pt and the estimated position value p. The estimated speed value v is estimated using values obtained from, for example, the GPS sensor 41, the acceleration sensor 42, and the angular velocity sensor 43 of the state obtainer 34. The flight controller 35 sets a target attitude value St using the obtained target position Pt, the estimated position value p, and the estimated speed value v.

The flight controller 35 obtains an estimated attitude value s through the state obtainer 34. The estimated attitude value s is a flight attitude of the flying device 10 estimated from a value obtained from the angular velocity sensor 43 or the like of the state obtainer 34. The flight attitude corresponds to a rotation angle around each of a roll axis, a pitch axis and a yaw axis of the flying device 10. The flight controller 35 sets an RPYT instruction value by applying an attitude change estimated value sr to the set target attitude value St and the obtained estimated attitude value s. RPYT is an abbreviation of Roll, Pitch, Yaw, and Thrust. The attitude change estimated value sr is an estimated value of the amount of change required to bring the flight attitude of the flying device 10 to the target attitude value St. The flight controller 35 obtains, as the posture change estimated value sr, the amount of change of each of a rotation angle R of the flying device 10 about the roll axis, a rotation angle P of the flying device 10 about the pitch axis, and a rotation angle Y of the flying device 10 about the yaw axis. Then, the flight controller 35 sets the RPYT instruction value Ds from the obtained attitude change estimated value sr. The RPYT instruction value Ds includes an attitude instruction value, for identifying the rotation angle R about the roll axis, the rotation angle P about the pitch axis, the rotation angle Y about the yaw axis, and a flying device flight speed T based on the obtained attitude change estimated value sr. The flight controller 35 sets the rotation number of the motor 14 in the thruster 12 as the rotation number instruction value Rx based on the set RPYT instruction value Ds. The rotation number instruction value Rx is an instruction value for setting the thrust generated by the thruster 12.

The rotation number instruction value Rx output from the flight controller 35 of the main controller 30 is input to the instruction value obtainer 53 of the thruster controller 50. The inputted rotation number instruction value Rx is generated by the instruction value generator 54 as the propeller pitch instruction value Px and the corrected rotation number instruction value Rr, The instruction value generator 54 outputs the generated propeller pitch instruction value Px to the servomotor 21 of the pitch changing mechanism 16. At the same time, the instruction value generator 54 outputs the generated corrected rotation number instruction value Rr to the motor 14 of the thruster 12. In the manual control mode, a process is performed as shown in FIG. 7.

The flight controller 35 of the main controller 30 sets the target attitude value St based on the operation of the operator input from the operating device 36. The flight controller 35 sets the RPYT instruction value Ds by applying the attitude change estimated value sr to the target attitude value St that is set based on the operation of the operator and the estimated attitude value s obtained through the state obtainer 34. The flight controller 35 sets the rotation number of the motor 14 in the thruster 12 as the rotation number instruction value Rx based on the set RPYT instruction value Ds. The rotation number instruction value Rx output from the flight controller 35 of the main controller 30 is input to the instruction value obtainer 53 of the thruster controller 50. The inputted rotation number instruction value Rx is generated by the instruction value generator 54 as the propeller pitch instruction value Px and the corrected rotation number instruction value Rr. The instruction value generator 54 outputs the generated propeller pitch instruction value Px to the servomotor 21 of the pitch changing mechanism 16. At the same time, the instruction value generator 54 outputs the generated corrected rotation number instruction value Rr to the motor 14 of the thruster 12.

In the first embodiment described above, the thruster controller 50 includes the instruction value obtainer 53. The instruction value obtainer 53 obtains the rotation number instruction value Rx output from the main controller 30 based on an assumption that the pitch of the propeller 15 in the thruster 12 is fixed. The instruction value generator 54 generates the propeller pitch instruction value Px and the corrected rotation number instruction value Rr from the rotation number instruction value Rx obtained by the instruction value obtainer 53. That is, the instruction value generator 54 generates the propeller pitch instruction value Px for setting the pitch of the propeller 15 from the obtained rotation number instruction value Rx, At the same time, the instruction value generator 54 corrects the obtained rotation number instruction value Rx based on the generated propeller pitch instruction value Px, and generates the corrected rotation number instruction value Rr for setting the rotation number of the motor 14. In the thruster 12, based on the propeller pitch instruction value Px output from the instruction value generator 54, the pitch changing mechanism 16 changes the pitch of the propeller 15. At the same time, in the thruster 12, the rotation number of the motor 14 is changed by the corrected rotation number instruction value Rr output from the instruction value generator 54. Thereby, in the flying device 10 provided with the pitch changing mechanism 16, the thrust generated from the thruster 12 is controlled using not only the rotation number of the motor 14 but also the pitch of the propeller 15. Therefore, even when the main controller 30 is used, which outputs the rotation number instruction value Rx based on an assumption that the pitch of propeller 15 is fixed, the pitch of propeller 15 is changeable, and the capacity of flying device 10 is fully exhibited.

In case of the flying device 10 provided with the pitch changing mechanism 16 in the thruster 12 as shown in the first embodiment, the thrust generated by the thruster 12 is changed not only by the rotation number of the motor 14 but also by the pitch of the propeller 15. In such a case, the responsiveness of the change of the thrust due to the change of the pitch of the propeller 15 is, for example, 10 times or more faster than that due to the change of the rotation number of the motor 14. Therefore, when controlling the thrust generated by the thruster 12, by using the change of the pitch of the propeller 15, the responsiveness to disturbances such as a sudden wind gust, for example, is improved and the stability of the flight state can be improved. In the first embodiment, the thruster controller 50 generates the propeller pitch instruction value Px and the corrected rotation number instruction value Rr by using the rotation number instruction value Rx output from the general-purpose main controller 30. Therefore, the thruster controller 50 of the first embodiment needs not have a modification to the main controller 30 such as a complication of the control system and/or dedicated circuit design. Therefore, it is possible to handle the change of the pitch of the propeller 15 for fully exhibiting the capacity of the flying device 10 and for the improvement of the stability of the flight, the responsiveness, and the efficiency, without causing the complication of the configuration, the specialization (i.e., dedicated design), and the like.

### Second Embodiment

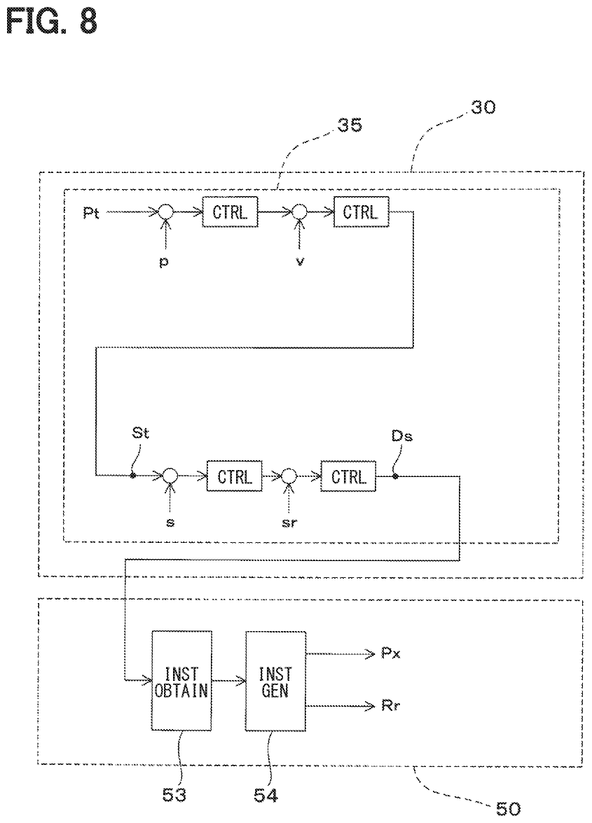

A thruster controller according to the second embodiment is described as follows. The configuration of the thruster controller 50 according to the second embodiment is the same as that of the first embodiment, however, the flow of processing is different from that of the first embodiment. The thruster controller 50 of the second embodiment obtains the RPYT instruction value Ds including the attitude instruction value from the flight controller 35 of the main controller 30 as shown in FIG. 8. That is, the flight controller 35 of the main controller 30 outputs the RPYT instruction value Ds instead of the rotation number instruction value Rx of the first embodiment. At the same time, the output RPYT instruction value Ds is input to the instruction value obtainer 53 of the thruster controller 50. The input RPYT instruction value Ds is generated by the instruction value generator 54 as the propeller pitch instruction value Px and the corrected rotation number instruction value Rr. The instruction value generator 54 outputs the generated propeller pitch instruction value Px to the servomotor 21 of the pitch changing mechanism 16. At the same time, the instruction value generator 54 outputs the generated corrected rotation number instruction value Rr to the motor 14 of the thruster 12. In such a case, the instruction value generator 54 uses at least one or more attitude instruction values among attitude instruction values corresponding to the rotation angle R, the rotation angle P, the rotation angle Y, or the flight speed T included in the RPYT instruction value Ds, for generating the propeller pitch instruction value Px and the corrected rotation number instruction value Rr.

In the second embodiment, the instruction value generator 54 uses the RPYT instruction value Ds including the plurality of attitude instruction values output from the flight controller 35 of the main controller 30 to set the propeller pitch instruction value Px and the corrected rotation number instruction value Rr. Thus, the instruction value generator 54 of the second embodiment uses an intermediate instruction value generated by the flight controller 35 (i.e., the RPYT instruction value Ds), instead of using the final rotation number instruction value Rx as in the first embodiment, for generating the propeller pitch instruction value Px and the corrected rotation number instruction value Rr. Thereby, the process in the flight controller 35 of the main controller 30 is simplified as compared with the first embodiment. Therefore, the responsiveness can be further improved. Note that, though the second embodiment is described as an example of the automatic control mode, the responsiveness of the manual control mode can be similarly improved in the same manner.

### Third Embodiment

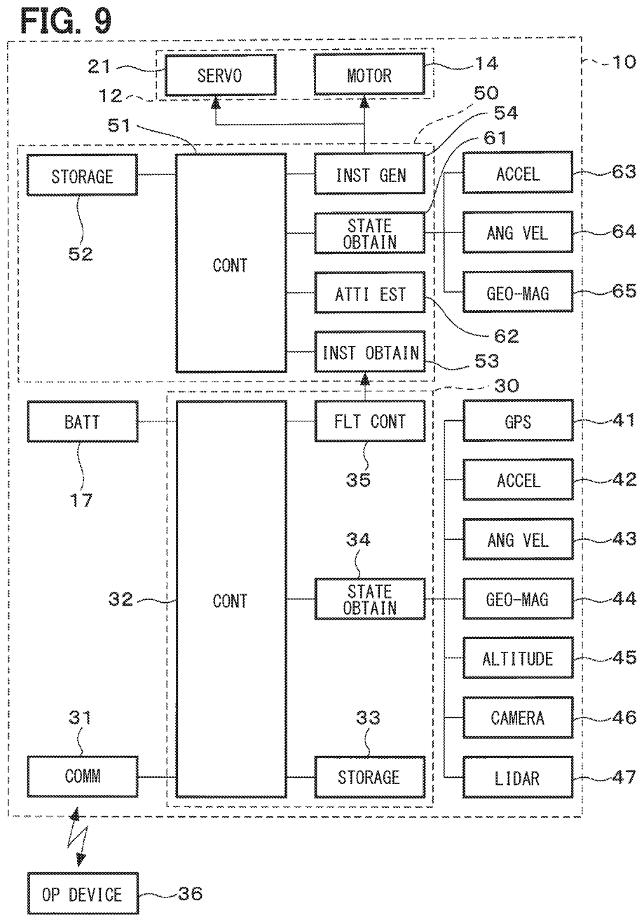

A thruster controller according to the third embodiment is described as follows, The thruster controller 50 according to the third embodiment is a modification of the second embodiment. As shown in FIG. 9, the thruster controller 50 according to the third embodiment includes a state obtainer 61 and an attitude estimator 62. The state obtainer 61 and the attitude estimator 62 are realized in the thruster controller 50 by software, hardware, or cooperation of software and hardware, The state obtainer 61 is connected to an acceleration sensor 63, an angular velocity sensor 64, and a geomagnetic sensor 65. In addition, the state obtainer 61 may be connected to a GPS sensor or an altitude sensor not shown. These various sensors have the same configuration as the sensors connected to the state obtainer 34 of the main controller 30. The attitude estimator 62 estimates the flight attitude of the flying device 10 on which the thruster controller 50 is mounted from the values detected by the acceleration sensor 63, the angular velocity sensor 64 and the geomagnetic sensor 65 in the state obtainer 61. That is, the attitude estimator 62 determines the flight attitude of the flying device 10 from the rotation angle of the main body 11 about the roll axis, the rotation angle of the main body 11 about the pitch axis, and the rotation angle of the main body 11 about the yaw axis. Then, the estimated flight attitude is output to the instruction value generator 54 as an estimated attitude value s1

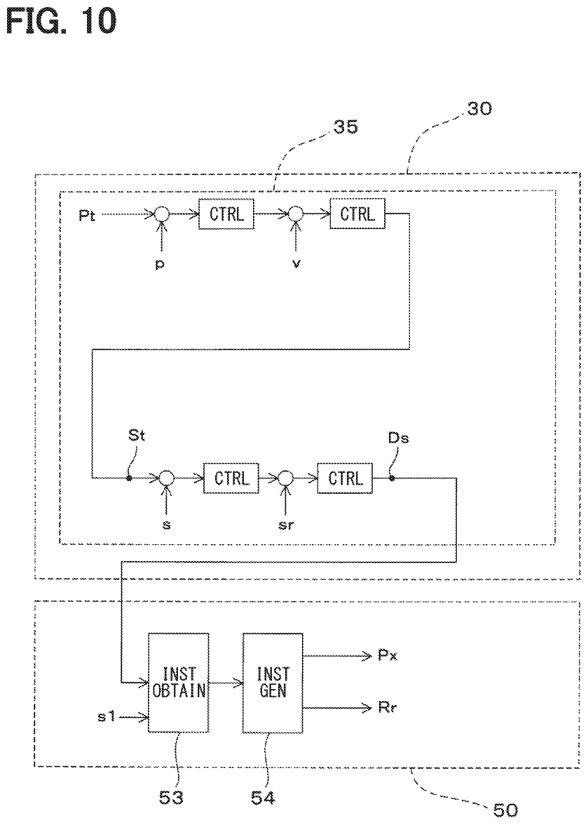

Thus, regarding the thruster controller 50 according to the third embodiment, as shown in FIG. 10, the instruction value generator 54 generates the propeller pitch instruction value Px and the corrected rotation number instruction value Rr using the estimated attitude value s1. That is, in addition to the RPYT instruction value Ds output from the flight controller 35 of the main controller 30, the instruction value generator 54 uses the estimated attitude value s1 estimated by the attitude estimator 62 to generate the propeller pitch instruction value Px and the corrected rotation number instruction value Rr. The instruction value generator 54 outputs the generated propeller pitch instruction value Px to the servomotor 21 of the pitch changing mechanism 16. At the same time, the instruction value generator 54 outputs the generated corrected rotation number instruction value Rr to the motor 14 of the thruster 12.

In the third embodiment, in addition to the RPYT instruction value Ds output from the flight controller 35 of the main controller 30, the instruction value generator 54 uses the estimated attitude value 51 estimated by the attitude estimator 62 to generate the propeller pitch instruction value Px and the corrected rotation number instruction value Rr. Thereby, the instruction value generator 54 changes the weight of the propeller pitch instruction value Px and the corrected rotation number instruction value Rr based on the flight attitude of the flying device 10 indicated by the estimated attitude value s1, Therefore, the propeller pitch instruction value Px and the corrected rotation number instruction value Rr can be set more appropriately, and the responsiveness and efficiency can be further improved.

In the third embodiment, it is determinable whether or not the flight state such as the flight attitude obtained by the state obtainer 34 of the main controller 30 is appropriate by generating the estimated attitude value s1 in the attitude estimator 62. Therefore, the effects of obvious errors and defects are eliminated. Thus, the security of flight can be further enhanced, and redundancy of control can be improved.

Note that, in the third embodiment, though the automatic control mode is described as an example, the same effect can be obtained in the manual control mode. Further, in the third embodiment, although the example using the RPYT instruction value Ds described in the second embodiment has been described, the present disclosure can also be applicable to the example using the rotation number instruction value Rx described in the first embodiment. Furthermore, in the third embodiment, an example in which the thruster controller 50 is provided with the state obtainer 61 has been described, However, the thruster controller 50 may estimate the flight attitude using data obtained by the state obtainer 34 of the main controller 30. Furthermore, the thruster controller 50 may be configured to share only various sensors with the main controller 30, and to independently estimate the flight attitude.

### Fourth Embodiment

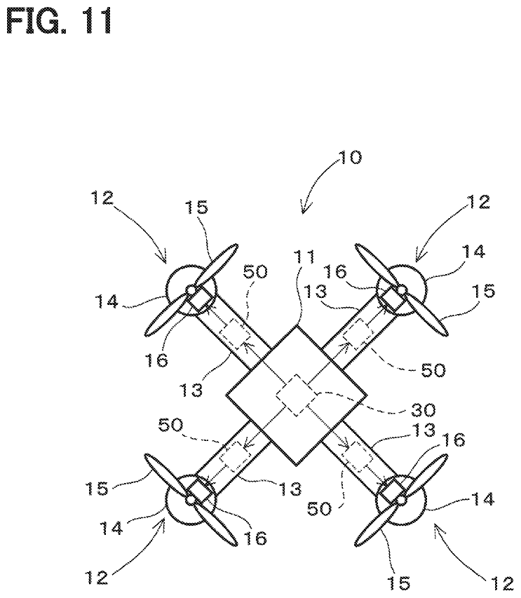

A thruster controller according to the fourth embodiment is described as follows. The thruster controller 50 can be configured to be respectively connected to a plurality of thrusters 12 as shown in FIG. 11. That is, in case of providing four thrusters 12 in the flying device 10 as shown in FIG. 11, four thruster controllers 50 are respectively provided corresponding to these four thrusters 12. Thus, the instruction value output from main controller 30 is input to thruster controller 50 connected to each thruster 12. The thruster controller 50 connected to each thruster 12 generates the propeller pitch instruction value Px and the corrected rotation number instruction value Rr with a weight suitable for the connected (i.e., relevant) thruster 12. Therefore, the responsiveness and efficiency can be further improved in the flying device 10 as a whole.

### Fifth Embodiment

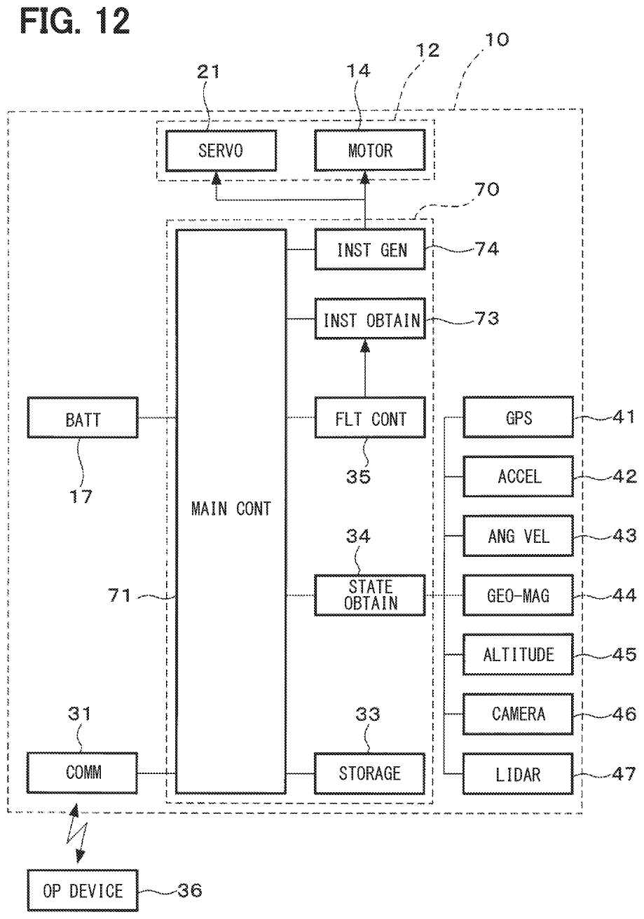

An attitude controller according to the fifth embodiment is described as follows. An attitude controller 70 according to the fifth embodiment is configured such that the main controller 30 and the thruster controller 50 in the plurality of embodiments described above are provided as an integrated, one device as shown in FIG. 12. That is, the attitude controller 70 according to the present embodiment is not a device (i.e., the main controller 30) having an add-on (i.e., the thruster controller 50 added thereto), but is a device initially designed as integral one. As a result, in the attitude controller 70, a main control unit 71 (i.e., an equivalent of the main controller 30 in the first embodiment) is provided with an instruction value obtainer 73 and an instruction value generator 74 which are respectively an equivalent of the thruster controller 50. In such a case, the components of the thruster controller 50 equivalent to the control operation unit 51 and the storage unit 52 may be shared with the main control unit 71 as shown in FIG. 12 or may be separately provided.

The attitude controller 70 according to the fifth embodiment has the main control unit 71 to which an instruction value obtainer 73 is connected, among which the main control unit 71 outputs an instruction value based on an assumption that the pitch of the propeller 15 is fixed, and the instruction value obtainer 73 obtains an instruction value from the main control unit 71. The instruction value obtainer 73 obtains an instruction value output from the flight controller 35 of the main control unit 71. The instruction value generator 74 generates the propeller pitch instruction value Px and the corrected rotation number instruction value Rr from the instruction value obtained by the instruction value obtainer 73. Thereby, when the thruster 12 of the flying device 10 is provided with the pitch changing mechanism 16, the thrust generated by the thruster 12 is controlled using not only the rotation number of the motor 14 but also the pitch of the propeller 15. Therefore, even when the instruction value is output based on an assumption that the pitch of the propeller 15 is fixed, the pitch of the propeller 15 is changeable, and the capacity of the flying device 10 can be fully exhibited, Further, in the fifth embodiment, the instruction value obtainer 73 and the instruction value generator 74 are added to the main control unit 71 which is an equivalent of the existing main controller 30, Therefore, a function for controlling the thruster 12 can be easily added without causing a large-scale change of the main control unit 71 or the like.

The above-described fifth embodiment has described the configuration in which the instruction value obtainer 73 and the instruction value generator 74 are added to the main control unit 71, i.e., to an equivalent of the main controller 30 in the first embodiment. However, the attitude controller 70 of the fifth embodiment is not limited to such a configuration of having a base in the first embodiment (i,e,, the main controller 30), but may have other configuration of having a base in other embodiments, to which the main control unit 71 has the instruction value obtainer 73 and the instruction value generator 74 are added.

The present disclosure is not limited to the embodiments described above but may also be modified in various ways without departing from the spirit of the disclosure. Although the present disclosure has been described in accordance with the embodiments, it is understood that the present disclosure is not limited to the embodiments and structures. The present disclosure covers various modification examples and modifications within equivalent scopes. Furthermore, various other combinations and formations, together with an addition thereto and/or a subtraction therefrom of one element or sub-element may also be encompassed within the scope of the disclosure.

What is claimed is:

1. A thruster controller for use in a flying device that includes (i) at least two thrusters each having a propeller, a motor driving the propeller, and a pitch changing mechanism changing a pitch of the propeller, and (ii) a main controller outputting an instruction value to the thruster for a control of a thrust generated by the thruster based on an assumption that the pitch of the propeller is fixed, and for controlling the thrust generated by the thruster at a position between the main controller and the thruster, the thruster controller comprising:
an instruction value obtainer configured to obtain the instruction value output from the main controller; and
an instruction value generator (a1) configured to generate a propeller pitch instruction value from the instruction value obtained by the instruction value obtainer for setting the pitch of the propeller and (a2) output the generated propeller pitch instruction value to the pitch changing mechanism while (b1) correcting the instruction value obtained by the instruction value obtainer based on the propeller pitch instruction value and (b2) generate a corrected rotation number instruction value for setting a rotation number of the motor and (b3) output the corrected rotation number instruction value to the motor.

2. The thruster controller of claim 1, wherein
the main controller outputs a rotation number instruction value as the instruction value for instructing the rotation number of the motor, and
the instruction value generator generates the propeller pitch instruction value and the corrected rotation number instruction value by using the rotation number instruction value.

3. The thruster controller of claim 1, wherein
the main controller outputs a plurality of attitude instruction values for setting a flight state of the flying device as the instruction value, and
the instruction value generator sets the propeller pitch instruction value and the corrected rotation number instruction value by using at least one of the plurality of attitude instruction values.

4. The thruster controller of claim 1 further comprising:
an attitude estimator estimating a flight attitude of the flying device, wherein
the instruction value generator generates the propeller pitch instruction value and the corrected rotation number instruction value by using the instruction value and the flight attitude of the flying device estimated by the attitude estimator.

5. The thruster controller of claim 1, wherein:
the thruster controller is provided by a same number as a number of the thruster in the flying device .

6. An attitude controller for a control of a thrust generated by a thruster in a flying device that includes at least two thrusters each having a propeller, a motor driving the propeller, and a pitch changing mechanism changing a pitch of the propeller, the attitude controller comprising:
a main control unit configured to output an instruction value to the thruster for a control of a thrust generated by the thruster based on an assumption that the pitch of the propeller is fixed, and
an instruction value obtainer configured to obtain the instruction value output from the main control unit; and
an instruction value generator configured to generate a propeller pitch instruction value from the instruction value obtained by the instruction value obtainer for setting the pitch of the propeller and output the generated propeller pitch instruction value to the pitch changing mechanism while correcting the instruction value obtained by the instruction value obtainer based on the propeller pitch instruction value and generate a corrected rotation number instruction value for setting a rotation number of the motor and output the corrected rotation number instruction value to the motor.
